(19) United States
(12) Patent Application Publication
(10) Pub. No.: US 2024/0289757 A1
(43) Pub. Date: Aug. 29, 2024

(54) Digital Wallet Implementing a Proportional Values Method of Aggregation

(71) Applicant: Larry Randal Witham, San Jose, CA (US)

(72) Inventor: Larry Randal Witham, San Jose, CA (US)

(21) Appl. No.: 18/243,903

(22) Filed: Sep. 8, 2023

Related U.S. Application Data
(60) Provisional application No. 63/486,970, filed on Feb. 25, 2023.

(51) Int. Cl. G06Q 20/10; G06Q 20/36

(52) U.S. Cl. CPC G06Q 20/10; G06Q 20/36

(57) ABSTRACT

A digital wallet application executing on a computing device is configured to monitor a distributed ledger maintained by a plurality of participants in a distributed ledger network to determine that an item having a value has been transferred to an address maintained by the digital wallet application. The digital wallet application is also configured to multiply the value of the item by one or more other values of one or more other items previously transferred to the address to generate a combined value. Then the digital wallet application is configured to present an indication of the combined value for display to a user.

### CROSS-REFERENCE TO RELATED APPLICATION

This application claims priority to and the benefit of the filing date of provisional U.S. Patent Application No. 63/486,970 entitled “Digital Wallet Implementing a Proportional Values Method of Aggregation,” filed on Feb. 25, 2023, the entire contents of which are hereby expressly incorporated herein by reference.

### TECHNICAL FIELD

The present disclosure relates generally to systems and methods for exchanging value having different units of account and/or units of measurement in the same digital wallet, and more particularly to distributed ledgers to record the transfer of and determine the proportional values for a combination of items sent to a digital wallet address.

### BACKGROUND

Traditionally, monetary value has been represented solely by magnitude. For example, US fiat currency is denominated in dollars which are real numbers. Digital currencies have also followed this model. For example, tokens on the Ethereum network, such as Ether, are represented by real number values.

Furthermore, the accounting of these magnitudes is generally supported by aggregating like sets (i.e., addition of like items). For example, ounces of silver (Ag) can be added to determine the total number of ounces of silver a person has. Likewise, the number of wrapped bitcoin (wBTC) a user receives in multiple transactions can be aggregated to determine the total number of wrapped bitcoin the user has. However, like sets typically carry a single monolithic unit of measurement or unit of account, such as dollars ($), Euros (€), wrapped bitcoin (wBTC), wrapped Ether (wETH), ounces (oz), kilograms (kg), seconds (s), gold (Au), silver (Ag), etc.

These systems are unable to combine value from different sets to determine a single value at for example, a digital wallet address based on a combination of items received at the digital wallet address.

### SUMMARY

Techniques, systems, apparatuses, components, devices, and methods are disclosed for a digital wallet application that multiplies the value of items having different units of account and/or units of measurement received at address(es) maintained by the digital wallet application to generate a combined value. The transfers of the items are recorded in a distributed ledger (e.g., blockchain) maintained by validating network nodes.

The digital wallet application may also multiply the units of account and/or units of measurement to generate a combined unit of account and/or measurement. For example, the digital wallet application may maintain an address that receives 2 kg of silver (Ag) and 3 meters of copper rod stock (Cu). Accordingly, the digital wallet application may multiply the items to determine the user has 6 kg-m of Ag—Cu. The digital wallet application may also determine the value (V) of each item in a particular currency by multiplying the quantity (q) of the item by the price (P) of the item per unit denominated in the particular currency. For example, the price of silver in dollars may be $100 per kg and the price of copper rod stock in dollars may be $3 per m. Accordingly, the digital wallet application may determine the user has $1800 worth of kg-m of Ag—Cu.

In some implementations, the digital wallet application does not merely multiply the values of items having different units of account and/or units of measurement together, but also uses individual asset divisors (D) to divide the value for each item by a proportional amount so that the product of the values (V₁, V₂, . . . Vₙ) divided by the product of the asset divisors (D₁, D₂, . . . Dₙ) amounts to a combined value (W) which is the same as the aggregate value of all items. In this manner, the values of the items are combined using multiplication but the resulting combined value is equivalent to an aggregation using addition.

Also in some implementations, the digital wallet application may express the asset divisors in exponential format so that D=e^{X}. In this manner values can also include complex numbers in addition to real numbers, where the asset divisor, D, for a complex number is expressed as D=e^{iθ}. In other implementations, the asset divisors may be expressed in a logarithm format, where D=ln(x) for example. In yet other implementations, the asset divisors may be expressed in any suitable format.

In other implementations, the combined value computation is performed by a smart contract executed in a distributed ledger network. For example, a combined value exchange smart contract may be deployed to the distributed ledger to receive requests to transfer items (including representations of those items) from one user to another user. The combined value exchange smart contract may then transfer the items to the other user and determine the combined value of the other user's wallet address by multiplying the values of the items in a similar manner as described above. In these implementations, the digital wallet application may monitor the distributed ledger to determine the balance of the address(es) maintained by the digital wallet according to the smart contract calculation rather than determining the balance itself.

By utilizing distributed ledgers and in some scenarios, smart contracts to exchange different items having different units of account and/or units of measurement, the combined value system maintains a trusted, secure, and immutable record of the transactions. The combined value system in conjunction with a distributed ledger, allows for the combining of items which do not have the same unit of account and/or unit of measurement. Accordingly, the combined value system can allow for the extraction of units of account and/or measurement from existing wallet assets to create new assets by recombining the extracted units of account and/or measurement. This recombination of new units of account and/or measurement may result in: 1) a new virtual currency made up of a basket of units of account, or 2) a new virtual asset made up of units of measurement. For example, a user may combine wEth and wBTC to create wEth-wBTC. Likewise, a new virtual asset representing a physical quantity can be created from the base units (e.g., seconds, meters, kilograms, amperes, kelvin, moles, candelas, etc.) of currently held wallet assets. By combining items which do not have the same unit of account and/or unit of measurement into a single combined value, the present embodiments may: 1) create new assets, and thus new markets for said assets, 2) create new financial instruments, and thus new markets for said instruments, 3) create a bridge between the units of measurement (e.g., in engineering and science) and the units of account (e.g., in accounting and commerce), thus creating the foundation for a new commercial ecosystem, and 4) reduce memory requirements compared to conventional systems which keep track of the aggregate value for the same unit of account and/or measurement separately. This can be particularly important in a distributed ledger system where each node stores its own copy of the distributed ledger. A small reduction in memory requirements for one node may result in a significant amount of memory savings across the distributed ledger network.

Furthermore, the combined value system can operate in the context of artificial intelligence systems and/or algorithms, such that bots can maintain digital wallets, create new assets, and trade the new assets.

One example embodiment of the techniques of this disclosure is a computing device including one or more processors, and a non-transitory computer-readable memory storing a digital wallet application thereon. When executed by the one or more processors, the digital wallet application causes the computing device to monitor a distributed ledger maintained by a plurality of participants in a distributed ledger network to determine that an item having a value has been transferred to an address maintained by the digital wallet application. The digital wallet application also causes the computing device to multiply the value of the item by one or more other values of one or more other items previously transferred to the address to generate a combined value. Moreover, the digital wallet application causes the computing device to present an indication of the combined value for display to a user.

Another example embodiment of the techniques of this disclosure is a method for deploying a smart contract for aggregating proportional values using a distributed ledger maintained by a plurality of participants. The method includes generating, by one or more processors, a smart contract configured to receive a request to transfer a value of an item to an address for a recipient of the value, multiply the value of the item by one or more other values of one or more other items previously transferred to the address to generate a combined value, and update a state database to store the combined value in association with the address for the recipient. The method also includes deploying, by the one or more processors, the smart contract to an address stored on the distributed ledger maintained by the plurality of participants in a distributed ledger network.

### BRIEF DESCRIPTION OF THE DRAWINGS

FIG. 1 illustrates a block diagram of a computer network and system on which a combined value system may operate in accordance with an example aspect of the present disclosure;

FIG. 2 is an exemplary distributed ledger system for recording transactions and executing smart contracts in a combined value system;

FIG. 3 illustrates exemplary validating network nodes and an exemplary transaction flow on a distributed ledger network in a combined value system;

FIG. 4 illustrates exemplary components of a network node on a distributed ledger network in a combined value system;

FIG. 5 illustrates an example blockchain having blocks of transactions;

FIG. 6 illustrates an example transaction recording a transfer of an item from a first address/user to a second address/user;

FIG. 7A illustrates an example digital wallet application display that presents indications of transactions sent to/from a digital address maintained by the digital wallet and an indication of the combined value for the digital wallet;

FIG. 7B illustrates the example digital wallet application display of FIG. 7A after an item has been transferred from the digital address maintained by the digital wallet;

FIG. 8A illustrates an example combined value smart contract state on a distributed ledger network for determining the combined value of items owned by a first address/user transferring an item to a second address/user; and

FIG. 8B illustrates additional smart contract data from the combined value smart contract state illustrated in FIG. 8A for determining the combined value of items owned by the second address/user that received the item from the first address/user.

### DETAILED DESCRIPTION

A distributed ledger is a storage mechanism for data, events, transactions, etc. that is maintained by several participants. More specifically, a distributed ledger is a way of achieving a distributed consensus on the validity or invalidity of information recorded in the distributed ledger. In other words, the distributed ledger provides decentralized trust to participants and observers. As opposed to relying on a central authority, a distributed ledger is a decentralized database in which a transactional record of changes to the ledger is maintained and validated by each node of a peer-to-peer network. One type of distributed ledger, a blockchain, is comprised of groupings of transactions organized together into a “block,” and ordered sequentially (thus the term “blockchain”). While the distributed ledgers discussed herein are referred to in the context of a blockchain, this is merely one example of a distributed ledger. Distributed ledgers may also include a tangle, a block lattice, or other directed acyclic graph (DAG), for example. In any event, nodes may join and leave the blockchain network over time and may obtain blocks from peer nodes that were propagated while the node was gone. Nodes may maintain addresses of other nodes and exchange addresses of known nodes with one another to facilitate the propagation of new information across the network in a decentralized, peer-to-peer manner.

The nodes that share the ledger form what is referred to herein as the distributed ledger network. The nodes in the distributed ledger network validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. A consensus rule may require that blocks and transactions adhere to format requirements and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Additions to the blockchain that satisfy the consensus rules are propagated from nodes that have validated the addition to other nodes known to the validating node. If all of the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule is disregarded by validating nodes that receive the change and the change is not propagated to other nodes. Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable.

The validation activities of nodes applying consensus rules on a blockchain network may take various forms. In one implementation, the blockchain may be viewed as a shared spreadsheet that tracks data such as the ownership of assets. In another implementation, the validating nodes execute code contained in “smart contracts” and distributed consensus is expressed as the network nodes agreeing on the output of the executed code.

A smart contract is a computer protocol that enables the automatic execution and/or enforcement of an agreement between different parties. In particular, the smart contract may be computer code that is located at a particular address on the blockchain. In some cases the smart contract may run automatically in response to a participant in the blockchain sending funds (e.g., a cryptocurrency such as bitcoin, ether, or another digital/virtual currency) to the address where the smart contract is stored. Additionally, smart contracts may maintain a balance of the amount of funds that are stored at their address. In some scenarios when this balance reaches zero the smart contract may no longer be operational.

The smart contract may include one or more trigger conditions, that, when satisfied, correspond to one or more actions. For some smart contracts, the action(s) performed may be determined based upon one or more decision conditions. In some instances, data streams may be routed to the smart contract so that the smart contract may detect that a trigger condition has occurred and/or analyze a decision condition.

For example, the smart contract may specify an equation, formula, or algorithm that operates upon values for items having different units of account and/or units of measurement. More specifically, the smart contract may multiply values together to generate a combined value for a distributed ledger address corresponding to a user. The smart contract may also multiply units of account and/or measurement together to generate a combined unit of account and/or measurement for the distributed ledger address.

Blockchains may be deployed in a public, decentralized, and permissionless manner, meaning that any party may view the distributed ledger, submit new information to be added to the ledger, or join the network as a validating node. Other blockchains are private (e.g., permissioned ledgers) that keep chain data private among a group of entities authorized to participate in the blockchain network. Other blockchain implementations may be both permissioned and permissionless whereby participants may need to be validated, but only the information that participants in the network wish to be public is made public.

In some implementations, a distributed ledger includes multiple blockchains such as a main blockchain and several side chains operating independently of the main blockchain. The side chains then interact with the main blockchain to provide some of the transaction data from the side chains to the main blockchain. In this manner, the side chains can be permissioned or private while the main blockchain is public or available to a larger number of entities than the side chains. Non-sensitive information from the side chains may be shared on the main blockchain. Also in some implementations, a distributed ledger includes multiple layers or separate blockchains executing in parallel that are maintained by the same validating nodes. Some of the transaction data from the blockchain for the first layer may be provided to the blockchain for the second layer or vice versa.

In one example, a distributed ledger in a combined value system may be maintained by validating nodes which transmit data to remote systems using one or more public and/or private networks, such as a private enterprise network, the Internet, a satellite, a cellular router, a backhaul Internet or other type backhaul connection. The validating nodes receive transactions broadcasted to the distributed ledger network by, for example, user devices. The nodes then validate the broadcasted transactions.

In another example, the validating nodes execute code contained in “smart contracts” and other devices act as “evidence oracles” which provide evidence related to market price per unit, for example, to the blockchain. Oracles may be systems, devices, or entities that connect a deterministic system with a non-deterministic system or data source.

In the following description, for the purposes of explanation, specific details are set forth in order to provide a thorough understanding of various implementations and examples. Various implementations may be practiced without these specific details. The figures and description are not intended to be restrictive.

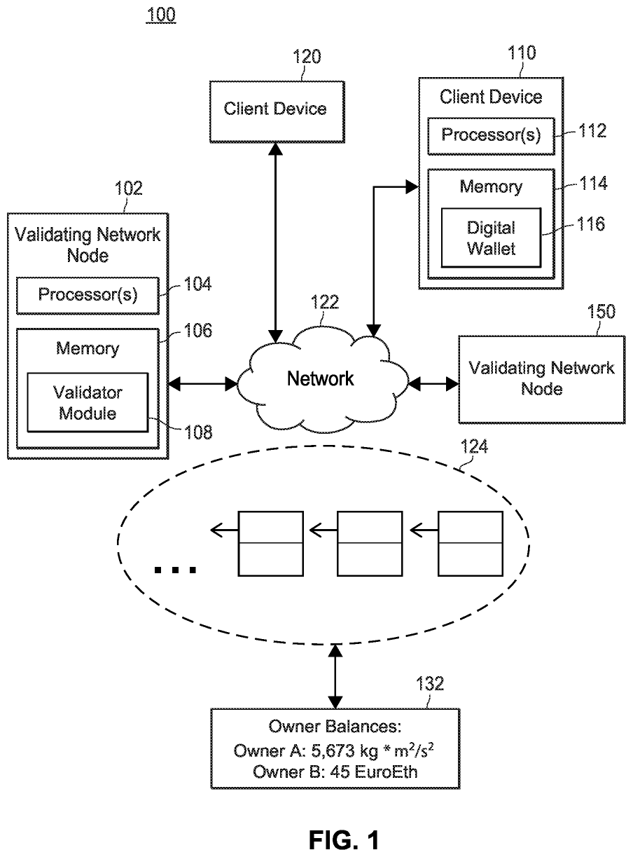

FIG. 1 illustrates various aspects of an example combined value system 100. The combined value system 100 may include validating network nodes 102, 150, and client devices 110, 120, which may be communicatively connected through a network 122 as described below. According to embodiments, the validating network nodes 102, 150 may be a combination of hardware and software components, also as described in more detail below with reference to FIG. 9. The validating network nodes 102, 150 may each include a memory 106, one or more processors 104 such as a microcontroller or a microprocessor, and other components not shown in FIG. 1 (e.g., a random-access memory (RAM), and/or an input/output (I/O) circuit), all of which may be interconnected via an address/data bus.

The memory 106 and/or RAM may store various applications for execution by the one or more processors 104. For example, a user interface application may provide a user interface to the validating network node 102, which user interface may, for example, allow the system administrator to configure, troubleshoot, and/or test various aspects of the node's operation.

The memory 106 may be tangible, non-transitory memory and may include any types of suitable memory modules, including RAM, read-only memory (ROM), flash memory, other types of persistent memory, etc. The memory 106 may store, for example, instructions executable on the processors 104 for a validator module 108.

The validator module 108 may validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain.

Another consensus rule may require that blocks and transactions adhere to format requirements and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

The validator module 108 may append distributed ledger data to the distributed ledger if the distributed ledger data satisfies the consensus rules by generating a new block of validated transactions to include in the distributed ledger 124 and/or by broadcasting a block of transactions to other network nodes. Otherwise, the validator module 108 disregards any distributed ledger data that does not satisfy the consensus rules, and the distributed ledger data is not propagated to other network nodes. For example, as shown in FIG. 1, the distributed ledger 124 indicates the balances 132 of users or owners at respective distributed ledger addresses and their corresponding units of account and/or measurement. More specifically, the distributed ledger 124 may indicate that Owner A has a balance of 5,673 kg*m²/s² and Owner B has a balance of 45 EuroEth. The validating network nodes 102, 150 are discussed in more detail below.

The client devices 110, 120 may include, by way of example, a tablet computer, a cell phone, a personal digital assistant (PDA), a mobile device smart-phone also referred to herein as a “mobile device,” a laptop computer, a desktop computer, a portable media player, a wearable computing device, smart glasses, smart watches, phablets, other smart devices, devices configured for wired or wireless RF (Radio Frequency) or optical communication, etc. Of course, any network-enabled device appropriately configured may interact with the combined value system 100. The client device 110 need not necessarily communicate with the network 122 via a wired connection. In some instances, the client device 110 may communicate with the network 122 via wireless signals and, in some instances, may communicate with the network 122 via an intervening wireless or wired device, which may be a wireless router, a wireless repeater, a base transceiver station of a mobile telephony provider, an optical communications device, etc.

The client device 110 may include a memory 114, one or more processors 112 such as a microcontroller or a microprocessor, and other components not shown in FIG. 1 (e.g., a display, a communication unit, a user-input device, a RAM, and/or an I/O circuit), all of which may be interconnected via an address/data bus. The memory 114 may include an operating system, a data storage, a plurality of software applications, and/or a plurality of software routines. The operating system, for example, may include one of a plurality of mobile platforms such as the iOS®, Android™, Palm® webOS, Windows Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage may include data such as user profiles, application data for the plurality of applications, routine data for the plurality of routines, and/or other data necessary to interact with the validating network nodes 102, 150 through the digital network 122. In some embodiments, the one or more processors 112 may also include, or otherwise be communicatively connected to, other data storage mechanisms (e.g., one or more hard disk drives, optical storage drives, solid state storage devices, etc.) that reside within the client device 110.

The communication unit may communicate with the validating network nodes 102, 150 via any suitable wireless communication protocol network, such as a wireless telephony network (e.g., GSM, CDMA, LTE, etc.), a Wi-Fi network (802.11 standards), a WiMAX network, a Bluetooth network, etc.

The user-input device may include a “soft” keyboard that is displayed on the display of the client device 110, an external hardware keyboard communicating via a wired or a wireless connection (e.g., a Bluetooth keyboard), an external mouse, or any other suitable user-input device.

The one or more processors 112 may be adapted and configured to execute any one or more of the plurality of software applications and/or any one or more of the plurality of software routines residing in the memory, in addition to other software applications. One of the plurality of applications may be a client application that may be implemented as a series of machine-readable instructions for performing the various tasks associated with receiving information at, displaying information on, and/or transmitting information from the client device 110.

One of the plurality of applications may be a native application and/or web browser, such as Apple's Safari®, Google Chrome™, Microsoft Internet Explorer®, and Mozilla Firefox® that may be implemented as a series of machine-readable instructions for receiving, interpreting, and/or displaying web page information while also receiving inputs from the user. Another application of the plurality of applications may include an embedded web browser that may be implemented as a series of machine-readable instructions for receiving, interpreting, and/or displaying web page information. One of the plurality of routines may include a combined value send routine which receives a quantity of an item that the user wants to send, and an address to which to send the amount, and then sends the quantity along with the corresponding unit of account and/or measurement to the address by generating a transaction including the quantity, the corresponding unit of account and/or measurement, and the address, and broadcasting the transaction to, e.g., nodes 102, 150 of the distributed ledger network.

Preferably, a user may launch a digital wallet application 116 from a client device 110 to send and receive transactions including different items having different units of account and/or measurement. For example, the digital wallet application 116 may interact with the distributed ledger 124. The digital wallet application 116 may obtain a quantity of an item (including a representation of the item) that the user wants to send, the corresponding unit of account and/or measurement for the item, and an address in which to send to the quantity of the item. The digital wallet application 116 may then generate a transaction including the quantity (e.g., 3), the unit of account and/or measurement (e.g., kg Ag), and the address, and broadcast the transaction to nodes 102, 150 of the distributed ledger network that maintain the distributed ledger 124. To receive an item (including a representation of the item), the digital wallet application 116 may include user controls for presenting a distributed ledger address associated with the digital wallet application 116. A user may then transmit an indication of the distributed ledger address (e.g., a QR code including the address, a set of alphanumeric characters indicating the address, etc.) to another user who is sending the item. The digital wallet application 116 may also interact with smart contracts to exchange items having different units of account and/or measurement.

It will be appreciated that although only two client devices 110, 120 and two validating network nodes 102, 150 are depicted in FIG. 1, any suitable number of client devices 110, 120 and any suitable number of validating network nodes 102, 150 may be included in the combined value system. In some instances, client device 110, 120 may also operate as validating network nodes 102, 150 and/or validating network nodes 102, 150 may also operate as client devices 110, 120.

The client devices 110, 120 and validating network nodes 102, 150 may communicate with each other via the network 122. The digital network 122 may be a proprietary network, a secure public Internet, a virtual private network and/or some other type of network, such as dedicated access lines, plain ordinary telephone lines, satellite links, a wireless telephony network, combinations of these, etc. Where the digital network 122 comprises the Internet, data communication may take place over the digital network 122 via an Internet communication protocol.

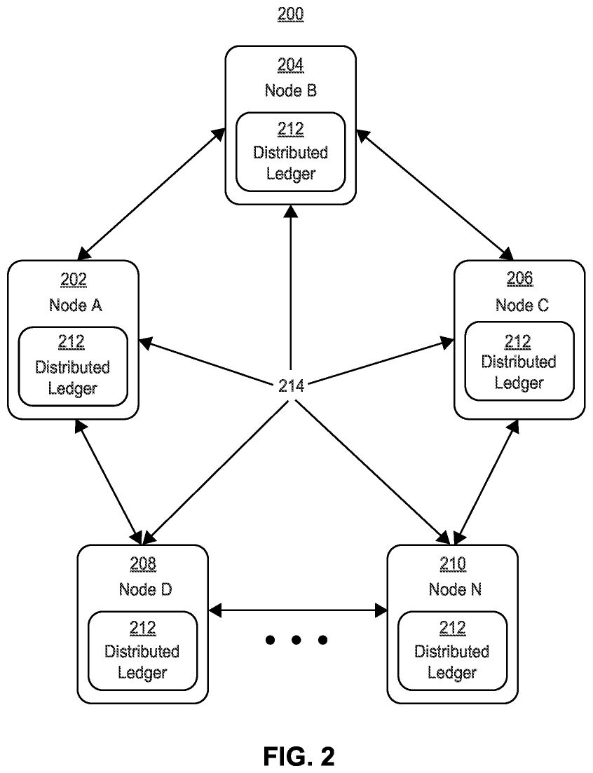

FIG. 2 depicts an exemplary distributed ledger system 200 for recording transactions and executing smart contracts in a combined value system 100. The system 200 includes a distributed ledger 212 (e.g., having one or more distributed ledger layers) and a plurality of nodes 202, 204, 206, 208, and 210 (e.g., each similar to node 102 or 150 of FIG. 1). Each node maintains a copy of the distributed ledger 212. As changes are made to the distributed ledger 212, each node receives the change via the network 214 and updates its respective copy of the distributed ledger 212. A consensus mechanism may be used by the nodes 202-210 in the distributed ledger system 200 to decide whether it is appropriate to make received changes to the distributed ledger 212 or to a particular layer of the distributed ledger 212.

Each node in the system therefore has its own copy of the distributed ledger 212, which is identical to every other copy of the distributed ledger 212 stored by the other nodes. The distributed ledger system 200 may be more robust than a central authority database system because of the distributed ledger's decentralized nature. As such, there is no single point of failure on the distributed ledger system 200 as there would be in a centralized system.

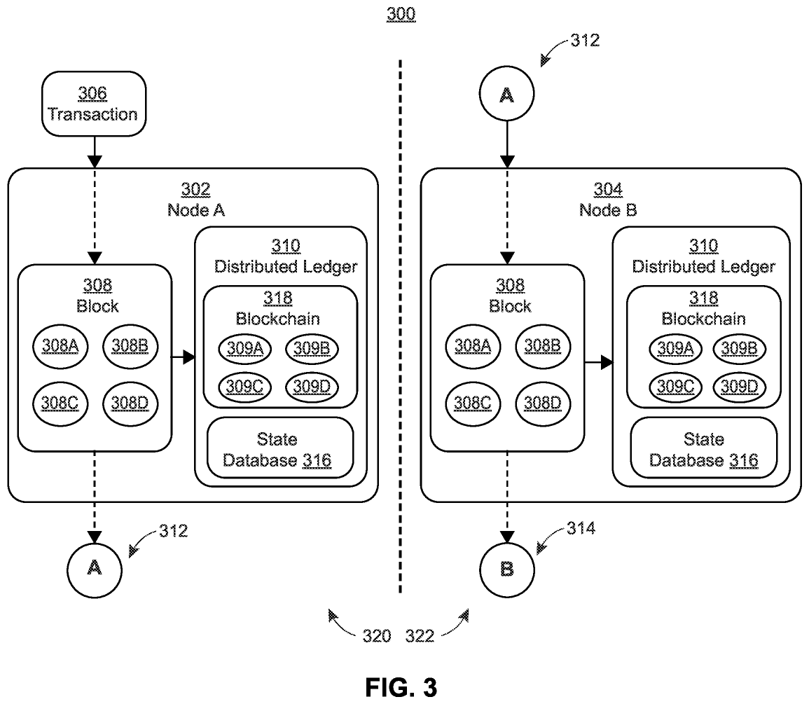

FIG. 3 depicts exemplary validating network nodes and an exemplary transaction flow 300 on a distributed ledger network for resolving transactions. FIG. 3 includes two time frames 320 and 322 represented by the left and right sides of the dotted line, respectively, Node A 302 (e.g., node 102) and Node B 304 (e.g., node 150), a set of transactions 308A-308D, a set of blocks of transactions 309A-309D, a distributed ledger 310, and a blockchain 318.

The block propagation flow 300 may begin with Node A 302 receiving transaction 306 at time 320. When Node A 302 confirms that transaction 306 is valid, Node A 302 may add the transaction to a newly generated block 308. As part of adding the transaction 306 to block 308, Node A 302 may solve a cryptographic puzzle and include the solution in the newly generated block 308 as proof of the work done to generate the block 308. Alternatively, a proof of stake algorithm may be used to generate the block 308, whereby Node A 302 “stakes” an amount of a digital token used on the network, however, the network itself determines the node that will mint the new block. In another implementation, a proof of authority (PoA) algorithm may be used to generate the block 308, where transactions and blocks are validated by approved accounts, known as validators which run software allowing them to record transactions in the distributed ledger.

In other embodiments, the transaction 306 may be added to a pool of transactions until a sufficient number of transactions in the pool exist to form a block or distributed ledger entry. Node A 302 may transmit the newly created distributed ledger entry 308 to the network at time 312. Before or after propagating the distributed ledger entry 308, Node A 302 may add the distributed ledger entry 308 to its copy of the distributed ledger 318.

While proof of work, proof of stake, and proof of authority are described herein as consensus algorithms for selecting a node to mint a new block, these are merely a few example consensus algorithms and are not intended to be limiting. Additional consensus algorithms may be utilized, such as delegated proof of stake where nodes elect a subset of nodes referred to as delegates to perform validation, and the delegates take turns minting new blocks. Consensus algorithms may also include proof of weight, Byzantine fault tolerance, tangle consensus algorithms, block lattice consensus algorithms, etc. Additionally, quorum slices may be selected where a quorum is a set of nodes that participate in the consensus protocol and a quorum slice is its subset that helps a node in its agreement process. Individual trust decisions may be made by participants in the distributed ledger network to construct a quorum slice. Still further, security circles may be identified which are closed groups of network participants who together can form a quorum to reach a consensus on a transaction and to make further trust decisions.

In any event, the transactions 309A-309D may include updates to a state database 316. The state database 316 may contain current values of variables created by smart contracts deployed on the distributed ledger 318. Validated distributed ledger entries, such as distributed ledger entry 308, may include transactions effecting state variables in state database 316. At time 322, Node B 304 may receive the newly created distributed ledger entry 308 via the network at 312. Node B 304 may verify that the distributed ledger entry 308 is valid by checking the solution to the cryptographic puzzle provided in the distributed ledger entry 308. If the solution is accurate, then Node B 304 may add the distributed ledger entry 308 to its distributed ledger 318 and make any updates to the state database 316 as rejected by the transactions in distributed ledger entry 308. Node B 304 may then transmit the distributed ledger entry 308 to the rest of the network at time 314.

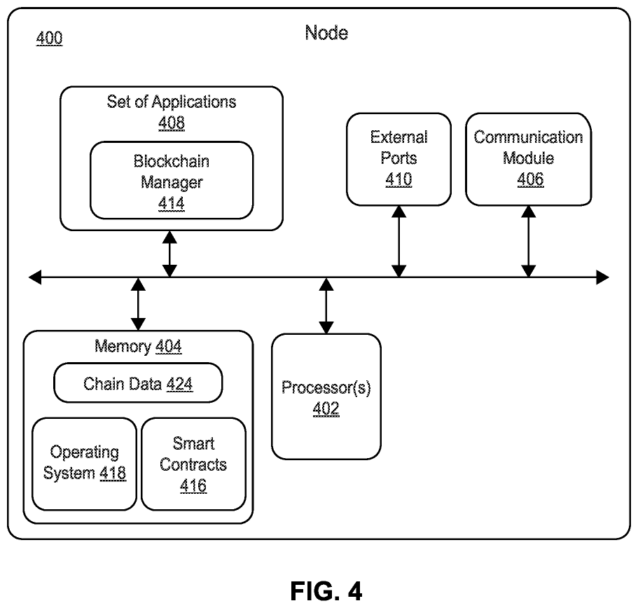

FIG. 4 depicts exemplary components of a validating network node 400 on a distributed ledger network for recording transactions and executing smart contracts in a combined value system. The validating network node 400 may be similar to the validating network nodes 102, 150 described above with reference to FIG. 1. Node 400 may include at least one processor 402, memory 404, a communication module 406 such as a transceiver, a set of applications 408, external ports 410, a blockchain manager 414, smart contracts 416, and an operating system 418. In some embodiments, the node 400 may generate a new block of transactions, or may broadcast transactions to other network nodes via the transceiver 406 by using the blockchain manager 414. Similarly, the node 400 may use the blockchain manager 414 in conjunction with the smart contracts 416 stored in the memory 404 to execute the functionality disclosed herein. The memory 404 may further include chain data 424 including, for example, a state database of the blockchain for storing states of smart contracts deployed thereon.

In other embodiments, the smart contracts 416 operate independent of the blockchain manager 414 or other applications. In some embodiments, the node 400 does not have a blockchain manager 414, or smart contracts 416 stored at the node. In some embodiments, the node 400 may have additional or fewer components than described.

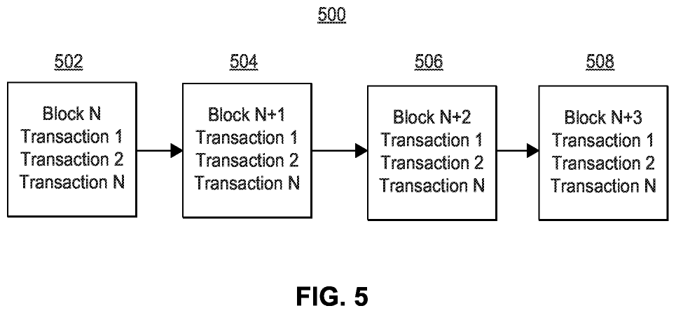

FIG. 5 depicts an exemplary distributed ledger 500 similar to the distributed ledger 124 as shown in FIG. 1. The example distributed ledger 500 includes a blockchain having blocks 502-508 of transactions. In some embodiments, the blockchain 500 includes several blocks 502-508 connected together to form a chain of blocks 502-508 of transactions. To cryptographically link blocks and transactions together, each block in the blockchain 500 organizes its transactions into a Merkle Tree. In a Merkle Tree each transaction is hashed according to a cryptographic hashing algorithm (e.g., SHA-256) and the resulting output hash is then combined with the hash of another transaction. Then the combined result is also hashed according to the cryptographic hashing algorithm. This output is then combined with the hash of two other transactions and this process is repeated until all of the transactions in the block are combined and hashed to generate a Merkle root that is used in the header for a block 502-508. If any single transaction in the block is tampered with, a different Merkle root would be generated since the Merkle root is a combination of the hashes of all of the transactions in the block.

In other words, the transactions may be hashed using a cryptographic hash algorithm, such as the algorithms discussed above, and the hash of each transaction may be stored in the tree. As the tree is constructed the hash of each adjacent node at the same level may be hashed together to create a new node that exists at a higher level in the tree. Therefore, the node at the top of the tree or Merkle root, is dependent upon the hash of each transaction stored below in the tree. Each transaction may include a set of data. The set of data may include identifying data for the transaction, and transaction data identifying the nature of the transaction and what the transaction entails (e.g., input and output addresses, a transaction value, a document hash value, a timestamp, a transaction fee value, etc.).

To verify that a block is valid, a node may compare the Merkle root of the block to the Merkle root for the same block included in other nodes' copies of the blockchain. Thus, the Merkle root can be used as proof of the transactions included in the block and as proof that the contents of the block have not been tampered with if the Merkle root is the same in each node's copy of the block.

In one implementation, documents stored “on” a blockchain are documents that have been hashed according to a cryptographic hashing algorithm (e.g., SHA-256) and the resulting output hash has been included in a transaction in a block that has been accepted by the network nodes as satisfying the consensus rules of the blockchain. As such, the documents may be later verified or validated by comparing the hash of the documents to the hash stored on the blockchain. For example, if a set of documents results in a SHA-256 hash that was recorded on a blockchain on a certain date, then the blockchain provides cryptographic proof that the documents existed as of that date.

One way of storing a document on a blockchain is to broadcast a transaction including a hash of the document to the network, which will be included in a block if the transaction satisfies all of the consensus rules of the network. In some implementations, the blockchain is a permissioned ledger, meaning only authorized network participants may broadcast transactions. In other implementations, only some authorized network participants may make certain transactions. Only a cryptographic hash of the data may be included in the blockchain 500, such that the data may be verified using the blockchain even if it is obtained by a party off-chain.

Validating network nodes may verify that the signed transaction or signed message was signed by the private cryptographic key corresponding to the published public cryptographic key owned by the user generating the transaction. In at least one implementation, a valid proof-of-identity may be applied as a consensus rule by the blockchain network. As such, any transaction attempting to exchange an item or interact with a smart contract without a cryptographic proof-of-identity matching an identity authorized to exchange an item or interact with a smart contract is rejected by the network as non-compliant with the consensus rule. Each owner may be assigned a public key/private key pair which is identified in the blockchain network as corresponding to the owner. If the validating network nodes receive a transaction that is not from an authorized owner, the validating network nodes reject the transaction.

For example, if the owner of a particular address corresponding to a public cryptographic key submits a transaction to transfer 2 wBTC to another owner at another address, the transaction must include a cryptographic proof-of-identity indicating that the owner is in possession of the private cryptographic key corresponding to the public cryptographic key for the particular address. This proves that the owner is in possession of the digital tokens at the particular address and is able to transfer the digital tokens from the particular address.

In some implementations, the blockchain 500 is a public blockchain meaning that any party may view the distributed ledger, submit new information to be added to the ledger, or join the network as a validating node. The distributed ledger may also include side chains which are private or permissioned blockchains that keep chain data private among a group of entities authorized to participate in the side blockchain network. In other embodiments, the main blockchain 500 is also a permissioned blockchain but the main blockchain 500 has a larger number of entities authorized to participate in the blockchain network than the side chains.

In addition to protecting privacy via side chains, in some embodiments, privacy may be preserved on the main blockchain 500. For example, the transactions in the blockchain 500 may obfuscate the identities of the parties to the transaction and the transaction amounts through various encryption techniques.

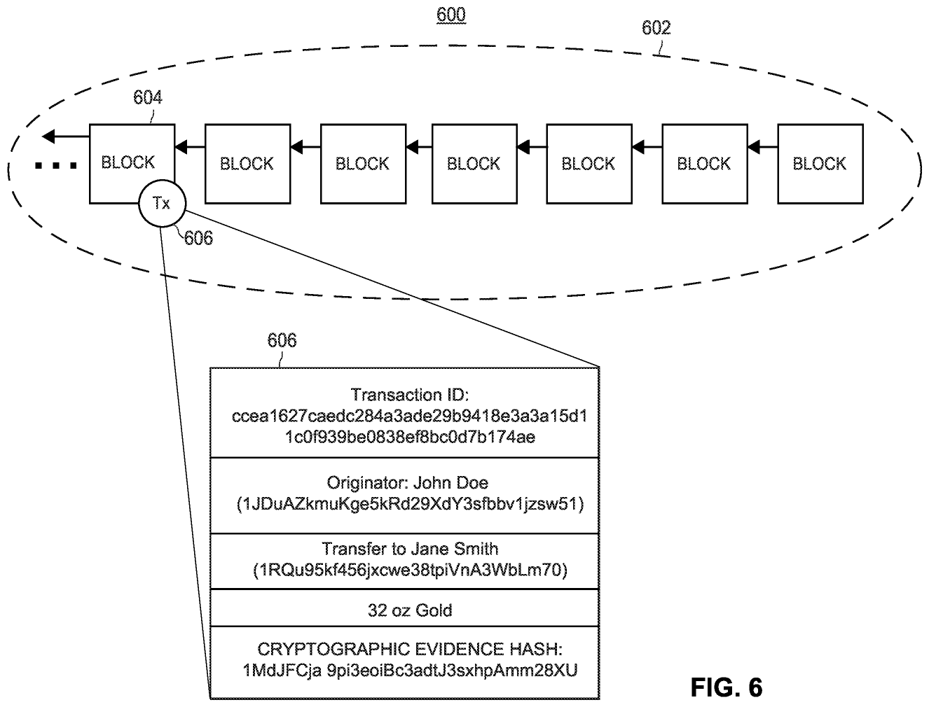

FIG. 6 illustrates an exemplary transaction 606 representing the transfer of an item (a representation of the item) from a first user (John Doe) to a second user (Jane Smith). The first user may broadcast the transaction 606, via the first user's client device 110 using the digital wallet application 116, to blockchain 602 to be included in a block, such as block 604.

The transaction 606 may include a transaction ID and an originator such as John Doe (identified by a cryptographic proof-of-identity and a blockchain address for John Doe). The transaction 606 may also include an indication that the transaction 1106 is a transfer of a particular item (Gold), a quantity of the item (32), a unit of account and/or measurement (oz Gold), and a blockchain address at which to transfer the item (Jane Smith's blockchain address).

Furthermore, the transaction 606 may include a cryptographic hash of the transaction information including the to and from addresses the transfer quantity, and the transfer unit of account and/or measurement. In another implementation, the information regarding the to and from address, the transfer quantity, and the transfer unit of account and/or measurement is not stored as a cryptographic hash, but is directly accessible in block 604 by an observer or other network participant.

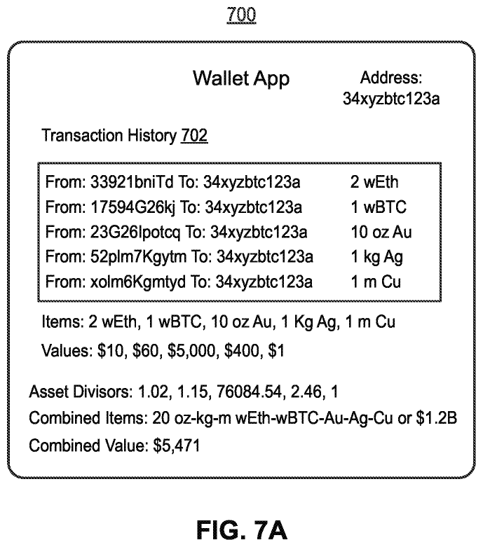

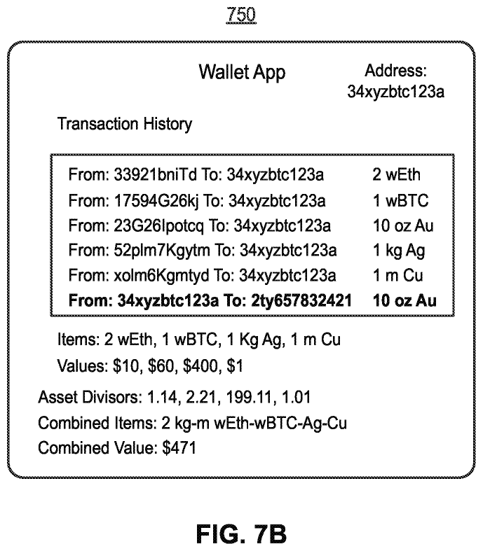

In some implementations, the combined value system 100 may use an unspent transaction output (UTXO) model to record unspent outputs for various items at a user's address. The digital wallet application 116 may then combine the values of the various items to determine the user's wallet balance. This is described in more detail below with reference to FIGS. 7A-7B. When the user transfers an unspent output for an item to another address for a transferee user, the digital wallet application 116 may divide out the value of the item from the combined value to determine the transferor user's updated wallet balance.

FIG. 7A illustrates an example digital wallet application display 700 which may be presented on a user interface of the client device 110 by the digital wallet application 116. The digital wallet application 116 may store the private keys for one or more distributed ledger addresses (e.g., 34xyzbtc123a), and may transfer value for items stored at the distributed ledger address(es) maintained by the digital wallet application 116.

As shown in FIG. 7A, the digital wallet application display 700 includes a transaction history 702 indicating each of the items transferred to and from the distributed ledger address(es) maintained by the digital wallet application 116. For example, the digital wallet application 700 may monitor the distributed ledger for transactions that include items transferred to or from the distributed ledger address(es) maintained by the digital wallet application 116. While the digital wallet application 116 as shown in FIG. 7A maintains one address (34xyzbtc123a), this is merely for ease of illustration only. The digital wallet application 116 may maintain any suitable number of addresses.

The transaction history 702 indicates that 2 wEth, 2 wBTC, 10 oz Au, 1 kg Ag, and 1 m Cu were received at the address. In some implementations, a user sends wrapped Ether, wrapped Bitcoin, or other wrapped digital currency rather than the digital currency itself so that each of the items can be transferred on the same blockchain. For example, the distributed ledger may utilize the Ethereum blockchain, the Solana blockchain, or any other suitable blockchain. To transact multiple different digital currencies on the same blockchain, a user may wrap each digital currency in a smart contract and create a wrapped version of the digital currency to transfer the wrapped version of the digital currency. The recipient of the wrapped version may send the wrapped version to the smart contract to redeem the digital currency on another blockchain.

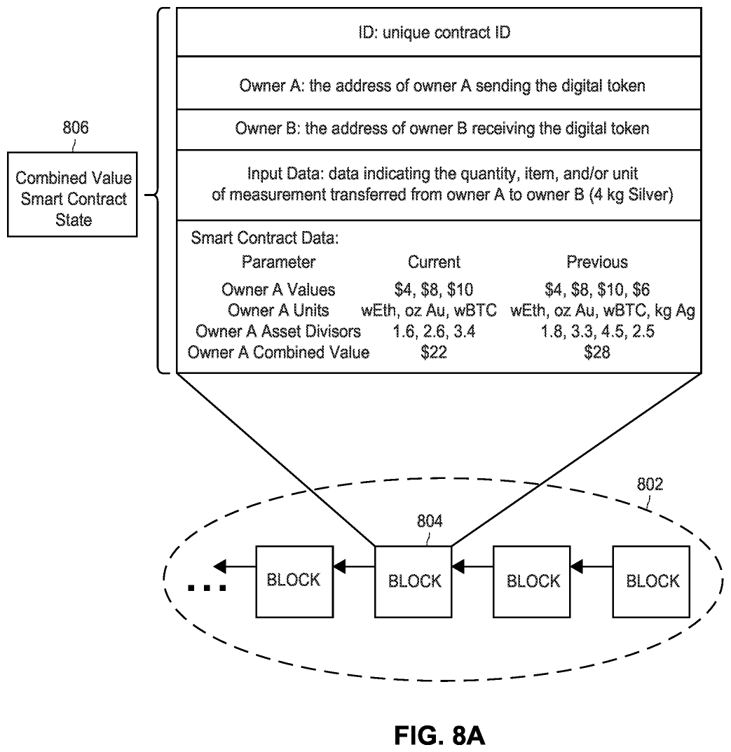

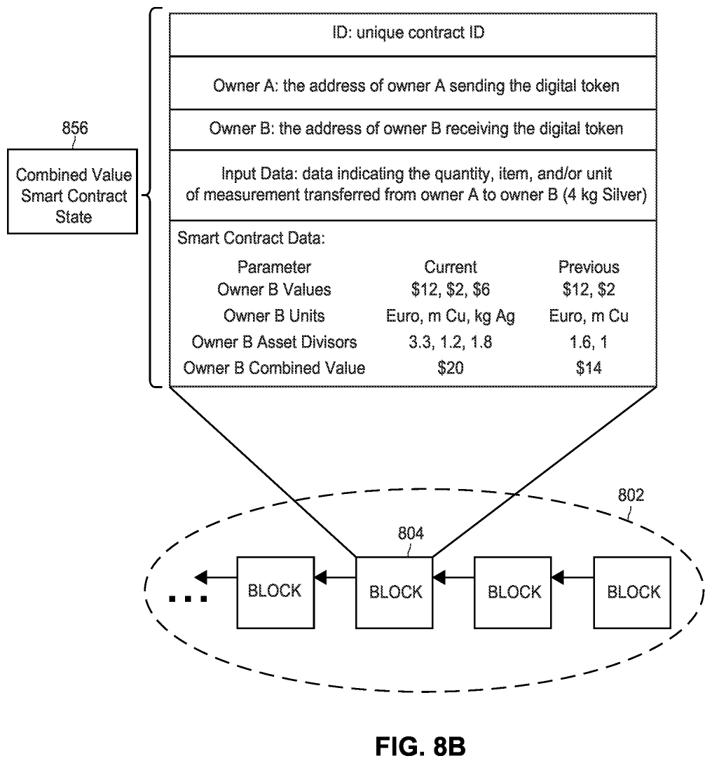

In any event, the digital wallet application 116 determines the value of each item by multiplying the quantity of the item by the price of the item per unit of account and/or measurement denominated in a particular currency. In the examples shown in FIGS. 7A-8B, the prices are denominated in US dollars ($). However, this is merely only example for ease of illustration only. The prices may be denominated in any suitable fiat or digital currency.

For example, the digital wallet application 116 may determine that the price per wEth is $5. Accordingly, the digital wallet application 116 multiplies the price ($5) by the quantity of wEth (2) to generate a value of $10 for wEth. The digital wallet application 116 may also determine that the price per wBTC is $60 and generates a value of $60 for wBTC. Furthermore, the digital wallet application 116 may determine that the price per ounce (oz) of gold is $500 and generates a value of $5,000 for 10 oz Au. Additionally, the digital wallet application 116 may determine that the price per kilogram (kg) of silver is $400 and generates a value of $400. Moreover, the digital wallet application 116 may determine that the price per meter (m) of copper rod stock is $1 and generates a value of $1. These prices may or may not reflect actual market prices of these items.

For each different item having a different unit of account and/or measurement, the digital wallet application 116 may multiply the value of the item by the values of the other items. For the same or like items, the digital wallet application 116 may add the value of the item to the value of other like items. When the user does not have any other items stored at the address, the digital wallet application 116 adds the value of the item rather than multiplying the value of the item by zero. Then the digital wallet application 116 begins to multiply values when there are values for at least two different items having different units of account and/or measurement.

Similarly, when the user transfers an item from the address to another address, the digital wallet application 116 may divide the value of the item by the combined values of the items if there are other items having different units of account and/or measurement. Additionally, the digital wallet application 116 may divide the combined unit of account and/or measurement for the address by the unit of account and/or measurement for the item to generate a new combined unit of account or unit of measurement for the address maintained by the digital wallet application 116. For the same or like items, the digital wallet application 116 may subtract the value of the item from the value of the like items. When the user does not have any other items stored at the address, the digital wallet application 116 subtracts the value of the item rather than dividing the value of the item by itself.

More specifically, as shown in FIG. 7A, the digital wallet application 116 may multiply the values ($10, $60, $5,000, $400, $1) of the items by each other and may multiply the units by each other to generate a combined value of $1.2B worth of oz-kg-m of wEth-wBTC-Au—Ag—Cu. The digital wallet application 116 may also multiply the quantity of the items by each other to generate a combined item value of 20 of oz-kg-m of wEth-wBTC-Au—Ag—Cu.

In some implementations, the digital wallet application 116 may generate an asset divisor (D) for each item to divide the value for each item by a proportional amount so that the product of the values (V₁, V₂, . . . Vₙ) divided by the product of the asset divisors (D₁, D₂, . . . Dₙ) amounts to a combined value (W) which is the same as the aggregate value of the items. To determine the asset divisors, the digital wallet application solves Equation 1 included below for D₁ through Dₙ.

$$W = {Π}_{1}^{n} ( \frac{{V}_{1}}{{D}_{1}} ) … ( \frac{{V}_{n}}{{D}_{n}} ) \qquad ( Eq . 1 )$$

where n is the number of items transferred to the address, Vis the value of each item, D is the asset divisor for each value, and W is the aggregate value of the items. To solve for D₁ through Dₙ, the digital wallet application 116 may represent each asset divisor in an exponential format such that D₁=e^{x1}, D₂=e^{x2}, . . . Dₙ=e^{xn}. Then the digital wallet application 116 solves Equation 2 for X₁+X₂+ . . . X₁ by dividing the product of the values by the aggregate value to generate a divided value and determining a natural logarithm of the divided value.

$${V}_{1} + … {V}_{n} = {Π}_{1}^{n} ( \frac{{V}_{1}}{{e}^{x 1}} ) … ( \frac{{V}_{n}}{{e}^{x n}} ) \qquad ( Eq . 2 )$$

$${X}_{1} + … {X}_{n} = ln ( \frac{{V}_{1} * … {V}_{n}}{{V}_{1} + … {V}_{n}} ) \qquad ( Eq . 3 )$$

Then the digital wallet application 116 determines the individual values of X₁, X₂, . . . X₁ in proportion to the values of their corresponding items as shown in Equation 4.

$${X}_{1} = ln ( \frac{{V}_{1} * … {V}_{n}}{{V}_{1} + … {V}_{n}} ) \frac{{V}_{1}}{{V}_{1} + … {V}_{n}} \qquad ( Eq . 4 )$$

The digital wallet application 116 then determines each asset divisor as the exponent of X to generate a proportional value for each asset divisor. In other implementations, the asset divisors may be expressed in a logarithm format, where D₁=ln(x₁) for example. In yet other implementations, the asset divisors may be expressed in any suitable format.

For example, as shown in FIG. 7A, the multiplied value of the items denominated in US dollars is $1.2B. This may be the numerator of the combined value as shown in Equation 1. The aggregate value, W, of the items is $5,471. Accordingly, the digital wallet application 116 takes the natural log of 1.2B divided by 5,471 which is 12.29837. Then the digital wallet application 116 determines X₁ for D₁ as 12.29837*10/5,471 which is 0.022479. The digital wallet application 116 determines D₁ as the exponent of 0.022479 which is 1.022734. The digital wallet application 116 determines X₂ for D₂ as 12.29837*60/5,471 which is 0.134875. The digital wallet application 116 determines D₂ as the exponent of 0.134875 which is 1.144394. The digital wallet application 116 determines X₃ for D₃ as 12.29837*5000/5,471 which is 11.2396. The digital wallet application 116 determines D₃ as the exponent of 11.2396 which is 76,084.54. The digital wallet application 116 determines X₄ for D₄ as 12.29837*400/5,471 which is 0.899168. The digital wallet application 116 determines D₄ as the exponent of 0.899168 which is 2.457558. The digital wallet application 116 determines X₅ for D₅ as 12.29837*1/5,471 which is 0.002248. The digital wallet application 116 determines D₅ as the exponent of 0.002248 which is 1.00225.

The digital wallet application 116 may store the asset divisors D₁ through D₅ for each of the values V₁ through V₅ corresponding to wEth, wBTC, oz Au, kg Ag, and m Cu, respectively. Then the digital wallet application 116 may multiply the values and divide by the product of the asset divisors,

$$( \frac{{V}_{1}}{{D}_{1}} ) * ( \frac{{V}_{2}}{{D}_{2}} ) … * ( \frac{{V}_{5}}{{D}_{5}} ) ,$$

to generate a combined value of $5,471.

FIG. 7B illustrates an example scenario where the user transfers an item (10 oz Au) from the distributed ledger address (34xyzbtc123a) to another distributed ledger address (2ty657832421). In the digital wallet application display 750, the digital wallet application 116 removes the item (10 oz Au) from the set of items and the value from the set of values. The digital wallet application 116 also recalculates the asset divisors according to Equation 1 to generate new asset divisors of 1.14, 2.21, 199.11, and 1.01 respectively. Then the digital wallet application 116 divides out the value of the transferred item (10 oz Au) from the combined value using the new asset divisors to generate a combined value of $471.

In addition to transferring items having real number values, the combined value system may transfer items having imaginary values or a real component and an imaginary component in a complex number. When an item includes a complex number the asset divisor may be represented as Dₙ=e^{iθn}. Accordingly, the combined value system may include transfers of 2+3i oz of gold and 3−2i oz of silver, for example.

In some scenarios, if the price per unit of an item is zero, the value of the item will go to zero which may result in a combined value of zero even if the other items have nonzero values. To address this issue, the digital wallet application 116 may remove this item from user's wallet/address. For example, the digital wallet application 116 may burn the item by transferring the item to a burn address which may not be maintained by another user. In other implementations, the digital wallet application 116 may obtain an artificial value floor (e.g., $0.00000001) for all items. If the value of an item is below that floor, the digital wallet application 116 assigns the artificial value floor as the value for the item. In yet other implementations, the digital wallet application 116 may implement a hybrid asset value (V′) with a limit approaching 1 as the price of the item approaches 0. For example, the hybrid asset value (V′) may be calculated according to Equation 5 included below, where Z is set to 1 when the price exceeds 0 and Z is set to 2 when the price is 0.

$${V}^{′} = \frac{Pq + ( q ( Z - 1 ) ( P + Z ) )}{Z} \qquad ( Eq . 5 )$$

where P is the price per unit of the item denominated in the particular currency (e.g., US dollars), q is the quantity of the item, and Z is set to 1 when P exceeds 0 and 2 when P is 0.

As an alternative to the UTXO model for determining users' wallet balances, the combined value system 100 may deploy a combined value smart contract to the distributed ledger to determine the wallet balance for each user or address. FIG. 8A depicts an exemplary combined value smart contract state 806 in a distributed ledger network for determining the combined value owned by a particular address/user. The smart contract may be deployed by any participant in the blockchain network (e.g., a client device 110) to establish the combined value smart contract state 806 for combining values for items having different units of account and/or measurement sent to a particular address/user. The deployed smart contract may expose methods and data to other participants in the blockchain network. Some of the data in the smart contract state may be private data that may only be altered by calling a method of the smart contract or only altered by authorized blockchain participants.

One way of altering the complex value smart contract state 806 is to broadcast a transaction to the blockchain 802. If the broadcast transaction satisfies consensus rules, network validators may include the transaction in a block 804. Inclusion in the blockchain 802 of a transaction sending data to the smart contract may cause validating nodes to update a state database, thus allowing network participants access to a rich state mechanism.

Combined value smart contract state 806 may include pieces of data to identify the smart contract, such a contract ID. The contract owner may also specify identities of owners of the distributed ledger addresses. In at least one implementation, the owners are identified by cryptographic public keys assigned to the respective owners. Subsequent data sent to the smart contract may include a message signed by private keys corresponding to the public keys identifying the owners in the smart contract, thus providing cryptographic proof that a transaction was originated by one of the owners. The private and public keys may be managed solely by the owners to minimize the attack surface for any attackers that might attempt to forge a transaction (e.g., the owners generate public/private cryptographic key pairs offline and only provide the public key to other network participants). An owner's private keys may be generated according to a securely stored seed value (e.g., on a piece of physical paper or multiple copies of a piece of paper) such that the private keys may be recovered in the case of a data loss.

Another aspect of the combined value smart contract state 806 is the smart contract data. Smart contract data may be thought of like the private and public data in an object created according to an object-oriented programming paradigm in that they may be directly updated from outside the object or they may be updated only in limited ways, such as by calling a function of the smart contract. In at least one implementation, smart contract data includes indications of the combined values and/or units of account and/or measurement at each owner's address. When items are transferred amongst users, the smart contract data may include indications of the combined values before the transfer and the current combined values after the transfer.

In an example scenario, an owner (owner A) may broadcast a transaction to the blockchain 1202, and more specifically, the smart contract indicating a transfer of 4 kg of silver (Ag) to owner B. For example, owner A may call a function in the smart contract for transferring an item from one address to another address and may provide owner A's address, owner B's address, the quantity of the item (4), and the unit of account and/or measurement (oz Ag) to transfer to the function.

In response to owner A calling the function, the smart contract may transfer 4 oz Ag from owner A's address to owner B's address. To determine owner A's balance after transferring the item, the smart contract may divide out the value of the 4 oz Ag divided by the asset divisor to generate a new combined value for owner A.

More specifically, the smart contract data may include each of the values ($4, $8, $10, $6) and units of account and/or measurement (wEth, oz Au, wBTC, kg Ag) before the transfer, the asset divisors (1.8, 3.3, 4.5, 2.5), and the combined value ($28). Then using the values, units of account and/or measurement, asset divisors, and combined value before the transfer, the smart contract may determine new asset divisors and a new combined value after the transfer according to Equations 1-4 to generate asset divisors of 1.6, 2.6, and 3.4 for values $4 wEth, $8 oz Au, and $10 wBTC, respectively. Then using the new asset divisors and the remaining values after dividing out the value of the 4 kg Ag transferred from owner A's address, the smart contract may multiply the remaining values and divide by the product of the new asset divisors to generate a new combined value of $22.

FIG. 8B depicts additional smart contract data for determining owner B's balance after the item is transferred from owner A to owner B. To determine owner B's balance after transferring the item, the smart contract may multiply the value of the 4 oz Ag divided by an asset divisor by the values of the other items stored at owner B's address divided by their respective asset divisors.

More specifically, the smart contract data may include each of the values ($12, $2) and units of account and/or measurement (Euro, m Cu) before the transfer, the asset divisors (1.6, 1), and the combined value ($14). Then using the values, units of account and/or measurement, asset divisors, and combined value before the transfer, the smart contract may determine new asset divisors and a new combined value after the transfer according to Equations 1-4 to generate new asset divisors of 3.3, 1.2, and 1.8 for values $12 of Euros, $2 of m Cu, and $6 of kg Ag, respectively. Then using the new asset divisors and the values after multiplying the value of the 4 kg Ag transferred to owner B's address, the smart contract may multiply the values and divide by the product of the new asset divisors to generate a new combined value of $20.

In some scenarios, if the price per unit of an item is zero, the value of the item will go to zero which may result in a combined value of zero even if the other items have nonzero values. To address this issue, the smart contract may remove this item from user's wallet/address. For example, the smart contract may burn the item by transferring the item to a burn address which may not be maintained by another user. In other implementations, the smart contract may obtain an artificial value floor (e.g., $0.00000001) for all items. If the value of an item is below that floor, the smart contract assigns the artificial value floor as the value for the item. In yet other implementations, the smart contract may implement a hybrid asset value (V′) with a limit approaching 1 as the price of the item approaches 0. For example, the hybrid asset value (V′) may be calculated according to Equation 5.

This detailed description is to be construed as exemplary only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A computing device comprising:
one or more processors; and
a non-transitory computer-readable memory storing a digital wallet application thereon that, when executed by the one or more processors, causes the computing device to:
monitor a distributed ledger maintained by a plurality of participants in a distributed ledger network to determine that an item having a value has been transferred to an address maintained by the digital wallet application;
multiply the value of the item by one or more other values of one or more other items previously transferred to the address to generate a combined value; and
present an indication of the combined value for display to a user.

2. The computing device of claim 1, wherein each item has an associated unit of account or unit of measurement, and wherein the digital wallet application further causes the computing device to multiply the unit of account or unit of measurement associated with the item with the one or more units of account or units of measurement associated with the one or more other items to generate a combined unit of account or unit of measurement.

3. The computing device of claim 2, wherein the digital wallet application further causes the computing device to:
obtain each value for each item transferred to the address;
obtain the associated unit of account or unit of measurement for each value; and
generate an asset divisor for each value, wherein the asset divisor is in an exponent format.

4. The computing device of claim 3, wherein an aggregate value, W, is determined as:
$$W = {Π}_{1}^{n} ( \frac{{V}_{1}}{{D}_{1}} ) … ( \frac{{V}_{n}}{{D}_{n}} ) ,$$
wherein n is the number of items transferred to the address, V is the value of each item, and D is the asset divisor for each value.

5. The computing device of claim 3, wherein the digital wallet application further causes the computing device to:
determine the asset divisor for each value by:
adding the values for each item to generate an aggregate value,
dividing the combined value by the aggregate value to generate a divided value,
determining a natural logarithm of the divided value, and
generating a proportional value for the asset divisor using the natural logarithm of the divided value.

6. The computing device of claim 5, wherein the proportional value for the asset divisor is determined based on a proportion of the value for the asset divisor to the aggregate value.

7. The computing device of claim 3, wherein the asset divisor is a complex number.

8. The computing device of claim 1, wherein the value of the item is the product of a quantity of the item and a price denominated in a particular currency of the item per unit of account or unit of measurement.

9. The computing device of claim 1, wherein the digital wallet application further causes the computing device to:
generate a transaction transferring a portion of the combined value corresponding to at least one of the items to another address;
transmit the transaction to at least one participant in a distributed ledger network of participants maintaining the distributed ledger; and
divide the combined value by the portion to generate a new combined value for the address maintained by the digital wallet application.

10. The computing device of claim 9, wherein the digital wallet application further causes the computing device to:
determine the unit of account or unit of measurement associated with the at least one item being transferred; and
divide the combined unit of account or unit of measurement by the unit of account or unit of measurement to generate a new combined unit of account or unit of measurement for the address maintained by the digital wallet application.

11. A method for deploying a smart contract for aggregating proportional values using a distributed ledger maintained by a plurality of participants, the method comprising:
generating, by one or more processors, a smart contract configured to:
receive a request to transfer a value of an item to an address for a recipient of the value;
multiply the value of the item by one or more other values of one or more other items previously transferred to the address to generate a combined value; and
update a state database to store the combined value in association with the address for the recipient; and
deploying, by the one or more processors, the smart contract to an address stored on the distributed ledger maintained by the plurality of participants in a distributed ledger network.

12. The method of claim 11, wherein each item has an associated unit of account or unit of measurement, and wherein the smart contract is further configured to multiply the unit of account or unit of measurement associated with the item with the one or more units of account or units of measurement associated with the one or more other items to generate a combined unit of account or unit of measurement.

13. The method of claim 11, wherein the smart contract is further configured to:
update the state database to store each value for each item transferred to the address;
update the state database to store the associated unit of account or unit of measurement for each value;
generate an asset divisor for each value, wherein the asset divisor is in an exponent format; and
update the state database to store the asset divisor for each value;

14. The method of claim 13, wherein an aggregate value, W, is determined as:
$$W = {Π}_{1}^{n} ( \frac{{V}_{1}}{{D}_{1}} ) … ( \frac{{V}_{n}}{{D}_{n}} ) ,$$
wherein n is the number of items transferred to the address, V is the value of each item, and D is the asset divisor for each value.

15. The method of claim 13, wherein the smart contract is further configured to:
determine the asset divisor for each value by:
adding the values for each item to generate an aggregate value,
dividing the combined value by the aggregate value to generate a divided value,
determining a natural logarithm of the divided value, and
generate a proportional value for the asset divisor using the natural logarithm of the divided value.

16. The method of claim 15, wherein the proportional value for the asset divisor is determined based on a proportion of the value for the asset divisor to the aggregate value.

17. The method of claim 13, wherein the asset divisor is a complex number.

18. The method of claim 11, wherein the value of the item is the product of a quantity of the item and a price denominated in a particular currency of the item per unit of account or unit of measurement.

19. The method of claim 11, wherein the recipient is an owner of the address, and the smart contract is further configured to:
receive a request to transfer a portion of the combined value corresponding to at least one of the items from the owner to another address for another recipient;
divide the combined value by the portion to generate a new combined value; and
update the state database to store the new combined value in association with the address for the owner.

20. The method of claim 19, wherein the smart contract is further configured to:
determine the unit of account or unit of measurement associated with the at least one item being transferred; and
divide the combined unit of account or unit of measurement by the unit of account or unit of measurement to generate a new combined unit of account or unit of measurement for the address maintained by the owner.
